(19) United States
(12) Patent Application Publication
(10) Pub. No.: US 2023/0201778 A1
(43) Pub. Date: Jun. 29, 2023

(54) MIXING ARRANGEMENT, MIXER SETTLER UNIT AND USE

(71) Applicant: OUTOTEC (FINLAND) OY, Espoo (FI)

(72) Inventors: Henri Fredriksson, Helsinki (FI); Antti Mäkelä, Helsinki (FI); Marko Latva-Kokko, Pori (FI); Jiliang Xia, Pori (FI); Lauri Mäenpää, Pori (FI); Teemu Ritasalo, Espoo (FI)

(73) Assignee: Metso Outotec Finland Oy, Tampere (FI)

(21) Appl. No.: 17/919,821

(22) PCT Filed: Apr. 20, 2020
(86) PCT No.: PCT/FI2020/050258

§ 371 Date: Oct. 19, 2022

(51) Int. Cl. B01F 27/1145; B01F 27/191; B01F 27/921; B01F 35/00; C22B 3/02

(52) U.S. Cl. CPC B01F 27/11451; B01F 27/191; B01F 27/921; B01F 35/55; C22B 3/02; B01F 2215/0431; B01F 2215/0422; B01F 2101/45

(57) ABSTRACT

A mixing arrangement for mixing two solutions, a mixer settler unit and a use. The mixing arrangement includes a mixing device arranged in the mixing space for rotating therein, the mixing device comprising at least two helical bars supported around a shaft and rising upwards from the bottom section of the mixing space. The helical bars are fixed to the shaft with support spokes. The ratio of the diameter (D) of the mixing device to the average diameter (T) of the mixing space, that is D/T, is 0.47 at most.

### BACKGROUND

The invention relates to a mixing arrangement for mixing two solutions.

The invention further relates to a mixer settler unit.

The invention still further relates to a use of the mixing arrangement

Mixer arrangements are used in solvent extraction processes to extend the contact time between the two liquid phases by providing adequate mixing to maintain the dispersion. In the mixer arrangements a mixer circulates the dispersion gently in a mixing space thereby preventing the liquids from settling. However, there are still needs for intensifying and quicken the solvent extraction processes.

### BRIEF DESCRIPTION

Viewed from a first aspect, there can be provided a mixing arrangement for mixing two solutions, wherein the mixing arrangement comprises a mixing device arranged in the mixing space for rotating therein, the mixing device comprising at least two helical bars supported around a shaft and rising upwards from the bottom section of the mixing space, the helical bars being fixed to the shaft with support spokes, wherein the ratio of the diameter D of the mixing device to the average diameter T of the mixing space, that is D/T, is 0.47 at most.

Thereby a mixing arrangement that shortens the separation time of the liquid phases in a settler unit arranged for receiving material from said mixing arrangement may be achieved.

Viewed from a further aspect, there can be provided a mixer settler unit comprising the mixing arrangement as described above, and a settler unit arranged for receiving material from said mixing arrangement.

Thereby a highly efficient mixer settler unit may be achieved.

Viewed from a further aspect, there can be provided use of the mixing arrangement as described above for solvent extraction in the hydrometallurgical recovery of metals.

Thereby a solvent extraction process being quick and effective may be achieved.

The arrangement, the mixer settler unit and the use are characterised by what is stated in the independent claims. Some other embodiments are characterised by what is stated in the other claims. Inventive embodiments are also disclosed in the specification and drawings of this patent application. The inventive content of the patent application may also be defined in other ways than defined in the following claims.

In one embodiment, the ratio D/T is selected in range of 0.38-0.47. An advantage is that the separation time of the liquid phases in a settler unit arranged for receiving material from said mixing arrangement may be shortened.

In one embodiment, the ratio D/T is selected in range of 0.40-0.45. An advantage is that the separation time of the liquid phases in a settler unit arranged for receiving material from said mixing arrangement may be optimized in relation to the power consumption of the mixing arrangement.

In one embodiment, the ratio of the height H of the helical bars to liquid surface height L, that is H/L, is 0.6 0.9, preferably 0.8-0.9. An advantage is that effectiveness of the arrangement for maintaining the dispersion may be increased.

In one embodiment, the ratio of the height H of the helical bars to the diameter D, that is H/D, is at least 1, preferably 1.5-2. An advantage is that effectiveness of the arrangement for maintaining the dispersion may be increased.

In one embodiment, the mixing device comprises at least three helical bars. An advantage is that amount of pressure pulses caused to the dispersion per revolution of the mixing device may be increased.

In one embodiment, the helical bar has a round profile. An advantage is that lower local shear forces are created.

In one embodiment, diameter of the helical bar is selected in range of 0.03×T-0.05×T. An advantage is that the mixing properties of the helical bar may be enhanced.

In one embodiment, the supporting spoke is straight, first end attached to the helical bar, and second end arranged to the shaft, wherein and the angle between the spoke and the shaft is 75°-105°, preferably 85°-95°, more preferably 90°. An advantage is that disturbance caused by the spokes to flow created by the helical bar may be decreased.

In one embodiment, the number of the supporting spokes is 6 to 12. An advantage is that a good balance between initial investment costs and structural strength of the mixing device may be achieved.

In one embodiment, the supporting spoke has a round profile. An advantage is that lower local shear forces are created.

In one embodiment, the mixing space has an upper part and a lower part, and wherein the ratio of the diameter TU of the upper part and the diameter TL of the lower part is selected in range of 0.8-1.2, preferably 0.9-1.1. An advantage is that a shape of the mixing space assisting formation and maintaining the dispersion may be achieved.

In one embodiment, the mixing space has a cylindrical shape. An advantage is that a shape of the mixing space assisting formation and maintaining the dispersion may be achieved.

In one embodiment, the mixing space has a shape of truncated cone. An advantage is that the mixing space may be manufactured e.g. by casting.

In one embodiment, the average diameter of the mixing space is at least 1000 mm, preferably 1000-5000 mm. An advantage is that a capacity of the arrangement suitable for industrial processes, such as a solvent extraction in the hydrometallurgical recovery of metals, may be achieved.

In one embodiment, the mixing space is provided with one or more blocking elements. An advantage is that flow pattern of the mixing arrangement may be optimized for formation and maintaining the dispersion.

In one embodiment, the blocking element has a shape that extends in the same direction as the shaft. An advantage is that flow pattern of the mixing arrangement may be optimized for formation and maintaining the dispersion.

In one embodiment, the blocking element is arranged to a side wall of the mixing space. An advantage is that the structure is simple.

In one embodiment, the blocking elements comprise a baffle. An advantage is that an effective structure for working flow pattern of the mixing arrangement may be achieved.

In one embodiment, the mixer settler unit comprises at least two mixing arrangements arranged in series, and the settler unit is arranged for receiving material from the last of said mixing arrangements. An advantage is that the retention time may be extended, and thus high efficiency may also be reached in highly demanding extraction processes.

In one embodiment, it is provided use of the mixing arrangement for solvent extraction in the hydrometallurgical recovery of at least one metal, preferably selected from Cu, Ni, Co, Mg, Mn, Zn, Fe, U and B. An advantage is that a process being quick and effective in the recovery of the metal may be achieved.

### BRIEF DESCRIPTION OF FIGURES

Some embodiments illustrating the present disclosure are described in more detail in the attached drawings, in which

FIG. 1 is a schematic side view of a mixer settler unit in partial cross-section,

FIG. 2 is a schematic perspective view of a mixing arrangement in partial cross-section,

FIG. 3 is a schematic side view of a mixing device of the mixing arrangement shown in FIG. 2,

FIG. 4 is a schematic top view of the mixing device of the mixing arrangement shown in FIG. 2,

FIG. 5 schematic side view showing a flow pattern of a mixing arrangement,

FIG. 6 schematic side view showing a flow pattern of another mixing arrangement,

FIG. 7 schematic side view showing a flow pattern of a third mixing arrangement,

FIG. 8 illustrates power requirement of some arrangements, and

FIG. 9 illustrates separation time results of the arrangements illustrated in FIG. 8.

In the figures, some embodiments are shown simplified for the sake of clarity. Similar parts are marked with the same reference numbers in the figures.

### DETAILED DESCRIPTION

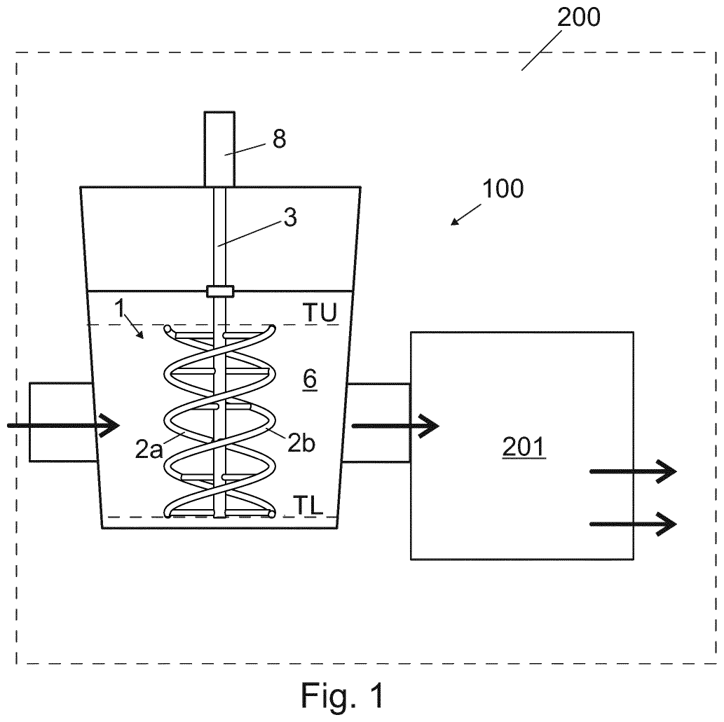

FIG. 1 is a schematic side view of a mixer settler unit in partial cross-section. The mixer settler unit 200 may be used for solvent extraction method used in hydrometallurgical recovery of metals. In a mixing arrangement 100, two mutually insoluble or poorly soluble solutions, fed from e.g. a pump in the mixing arrangement 100, are mixed together to form a dispersion. After the mixing, the dispersion is routed to a settler unit 201, in which the purpose is to separate the dispersion again into two pure layers one on top of the other.

The mixer settler unit 200 may comprise one mixing arrangement 100 (as in FIG. 1) or two or more mixing arrangements 100 arranged in series. In the latter case, the settler unit 201 is arranged for receiving material from the last of said mixing arrangements 100. The settler unit 201 may comprise one or more units.

The mixing arrangement 100 comprises a mixing device 1 that is arranged in a mixing space 6 for rotating therein. The mixing device 1 comprises at least two helical bars 2a, 2b that are attached to and around a shaft 3. The shaft is rotated by a motor 8, that is e.g. an electrical motor.

Apart from the mixing arrangement 100 and the settler unit 201, the mixer settler unit 200 may comprise further apparatuses, such as a pump, a piping etc.

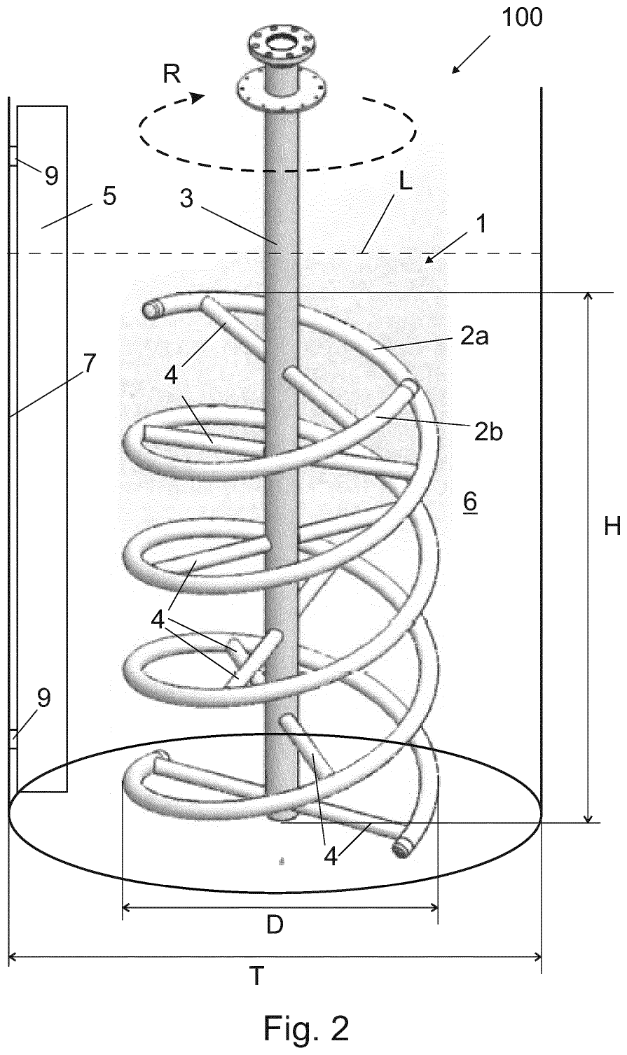

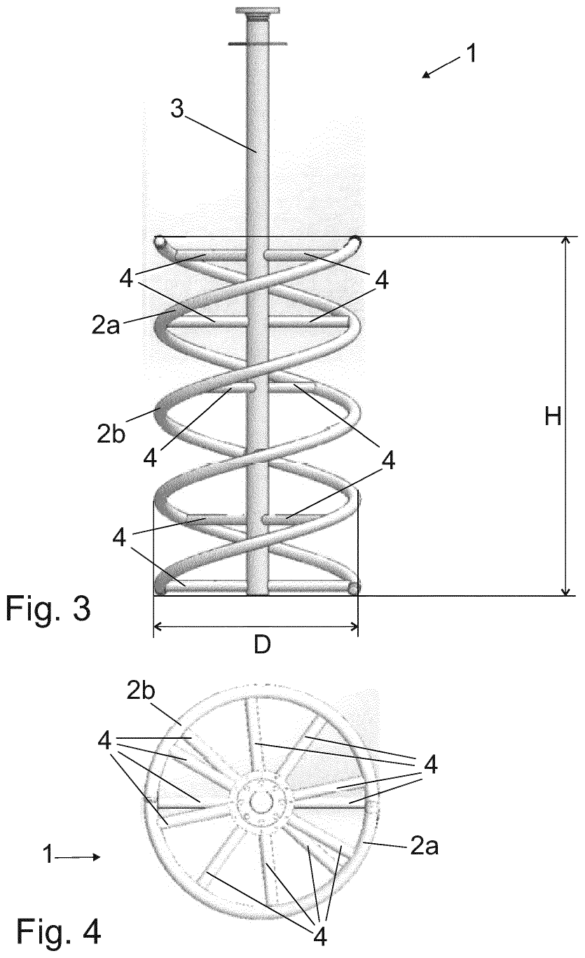

FIG. 2 is a schematic perspective view of a mixing arrangement in partial cross-section, FIG. 3 is a schematic side view of a mixing device of the mixing arrangement shown in FIG. 2 and FIG. 4 is a schematic top view of the mixing device of the mixing arrangement shown in FIG. 2.

The mixing arrangement 100 comprises a mixing device 1 arranged in a mixing space 6. The mixing device 1 comprises at least two helical bars 2a, 2b supported around a shaft 3 and rising upwards from the bottom section of the mixing space 6. The rotation direction R of the mixing device is shown in FIG. 2. It is to be noted, however, that if the rising direction of the bars 2a, 2b is opposite to that shown in FIG. 2, also the rotation direction R is opposite to that shown in FIG. 2.

In an embodiment, the mixing device 1 is arranged at a distance from the bottom wall of the mixing space 6, as best shown in FIG. 1. Said distance may be e.g. in the order of 3-16%, for instance 5%, of average diameter T of the mixing space. An advantage is that the mixing device 1 is easy to install and maintain in the apparatus. In another embodiment, the mixing device 1 is arranged in contact with the bottom wall of the mixing space 6. The shaft 3 may, for instance, be bearing-mounted to the bottom wall. An advantage is that the mixing device is supported on both ends, and thus its structure is robust.

In an embodiment, the pitch angle of the bars 2a, 2b is selected to be between 10°-30° to the horizontal. In an embodiment, the pitch angle is selected in range of 11°-25°.

In an embodiment, the bars 2a, 2b travel two full turns around the shaft 3. The helical bars 2a, 2b are fixed to the shaft 3 with support spokes 4. It is to be noted, however, that the bars 2a, 2b may travel more or less than two full turns.

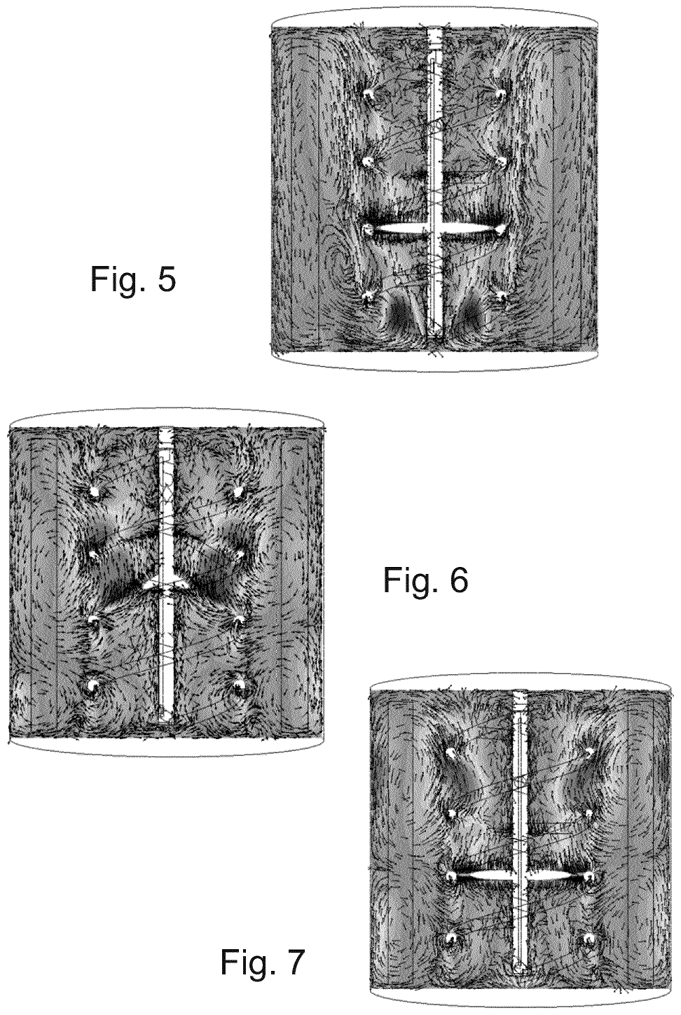

The ratio of the diameter D of the mixing device 1 to the average diameter T of the mixing space, that is D/T, is 0.47 at most. In one embodiment, the ratio D/T is selected in range of 0.38-0.47. In one embodiment, the ratio D/T is selected in range of 0.40-0.45. The effect of the ratio D/T to the mixing efficiency of the mixing arrangement 100 is discussed more detailed in connection with FIGS. 5-7.

In one embodiment, the ratio of the height H of the helical bars 2a, 2b to liquid surface height L, i.e. H/L, is 0.6-0.9. In another embodiment, said ratio H/L is 0.8 0.9.

In one embodiment, the ratio of the height H of the helical bars 2a, 2b to the diameter D of the mixing device 1, that is H/D, is at least 1. In one embodiment, H/D is 1.5-2.

In one embodiment (not shown), the mixing device 1 comprises at least three helical bars 2a, 2b.

In one embodiment, the helical bar 2a, 2b may comprise e.g. a metal tube.

In one embodiment, the helical bar 2a, 2b has a round profile. The diameter of the round bar 2a, 2b may be selected e.g. in range of 0.03×T-0.05×T.

In another embodiment, the profile of the helical bar 2a, 2b has an elliptical shape. In still another embodiment, the profile of the helical bar 2a, 2b has a polygon shape.

In one embodiment, the supporting spoke 4 is straight, a first end of which is attached to the helical bar 2a, 2b and a second end arranged to the shaft 3. The supporting spoke 4 shown in Figures is construed from a round metallic tube material. In another embodiment, the profile is elliptical. In still another embodiment, the shape is polygonal.

In an embodiment, both the helical bar 2a, 2b and the supporting spoke 4 have a round shape. The diameter of the spoke 4 may be at least essentially the same as of the helical bar, or alternatively, said diameters are essentially different.

The angle between the spoke 4 and the shaft 3 is selected in range of 75°-105°. In one embodiment, said angle is 85°-95°. In one embodiment, said angle is 90° or at least essentially 90°.

In one embodiment, the number of the supporting spokes 4 is selected in range of 6 to 12. The supporting spokes 4 are arranged on several locations or heights along the height H of the helical bars. In an embodiment, the supporting spokes 4 are arranged on three to six levels. In the embodiment shown in FIGS. 2-4, the spokes are arranged on six levels that are located at regular intervals along said height H, and the uppermost and the lowest spokes are arranged at the uppermost and the lowest end, respectively, of the helical bars, or at least close proximity thereof.

In an embodiment, the mixing space 6 has a circular cross-section as seen from above. The mixing space 6 has an upper part and a lower part. The upper part has an upper diameter TU, whereas the lower part has a lower diameter TL. The upper diameter TU is diameter measured at the level of the upper end of the helical bars, and the lower diameter TL is diameter measured at the level of the lower end of the helical bars 2a, 2b (as shown in FIG. 1).

In one embodiment, the ratio of the diameter TU of the upper part and the diameter TL of the lower part, i.e. TU/TL, is selected in range of 0.8-1.2, in another embodiment 0.9-1.1.

In one embodiment, such as shown in FIG. 2, the mixing space 6 has a cylindrical shape. In another embodiment, such as shown in FIG. 1, the mixing space 6 has a shape of truncated cone, wherein the diameter TU is larger than the diameter TL. In still another embodiment (not shown) the mixing space 6 has a shape of truncated cone, wherein the diameter TL is larger than the diameter TU. In still another embodiment (not shown) the shape of the mixing space 6 is a combination of cylindrical and conical shapes.

In one embodiment, the average diameter T of the mixing space is at least 1000 mm, preferably 1000-5000 mm.

In one embodiment, the mixing space 6 is provided with one or more blocking elements 5. The shape of the blocking element(s) 5 has a shape that extends in the same direction as the shaft 3. Thus, the blocking element 5 raises from lower parts of the mixing space 6 towards the upper parts thereof.

In one embodiment, the height of the blocking element 5 extends at least from the level of the lowest end of the helical bars 2a, 2b to at least the level of the uppermost end of said helical bars. In one embodiment, the blocking element 5 extends to or over the level of liquid surface height L. In another embodiment, the height of the blocking element 5 is smaller than the height H of the helical bars.

In one embodiment, the blocking element 5 is arranged or attached to a side wall 7 of the mixing space. In one embodiment, all the length of the blocking element 5 is in contact with the side wall 7. In another embodiment, the blocking element 5 is attached to the side wall 7 but at a distance therefrom by support elements 9.

In an embodiment, the blocking element 5 is a baffle. The baffle may be a vertical baffle. In another embodiment, the baffle is arranged in a position that deviates from the vertical direction.

In one embodiment, the blocking element 5 comprises a tube. The tube may be e.g. a part of a temperature controlling system (not shown) of the mixing space.

FIG. 5 schematic side view showing a flow pattern of a mixing arrangement, FIG. 6 schematic side view showing a flow pattern of another mixing arrangement and FIG. 7 schematic side view showing a flow pattern of a third mixing arrangement. In all these mixing arrangements the diameter of mixing space T is 2000 mm, and the tip speed of the mixing device was same in all the arrangements.

FIG. 5 is showing a mixing arrangement 100 wherein the ratio of the diameter D of the mixing device to the average diameter T of the mixing space, that is D/T, is 0.45. The supporting spokes 4 are straight and attached to the shaft 3 so that the angle between the spoke and the shaft is 90°.

As it can be readily seen, the flow pattern comprises a uniform downward flow close the side walls of the mixing space 6. Said uniform flow minimizes amount of energy needed for a sufficient flow in vertical direction that opposes gravitational separation of dispersion maintained in the mixing space 6. As the energy directed to the dispersion is lower, it is avoided, or at least reduced, formation of small-sized droplets in the dispersion. Also this phenomena assists in maintaining the dispersion.

FIG. 6 is showing a mixing arrangement 100 wherein the ratio of the diameter D of the mixing device to the average diameter T of the mixing space, that is D/T, is 0.50. The supporting spokes 4 are straight and attached to the shaft 3 so that there is an angle about 30° between the spoke and the shaft.

As it can be seen, the flow circulation loops in axial direction are more fragmented and local compared to the flow pattern shown in FIG. 5.

FIG. 7 is showing a mixing arrangement 100 wherein the ratio of the diameter D of the mixing device to the average diameter T of the mixing space, that is D/T, is 0.50. The supporting spokes 4 are straight and attached to the shaft 3 so that the angle between the spoke and the shaft is 90°.

Also here, the flow circulation loops in axial direction are more fragmented and local compared to the flow pattern shown in FIG. 5.

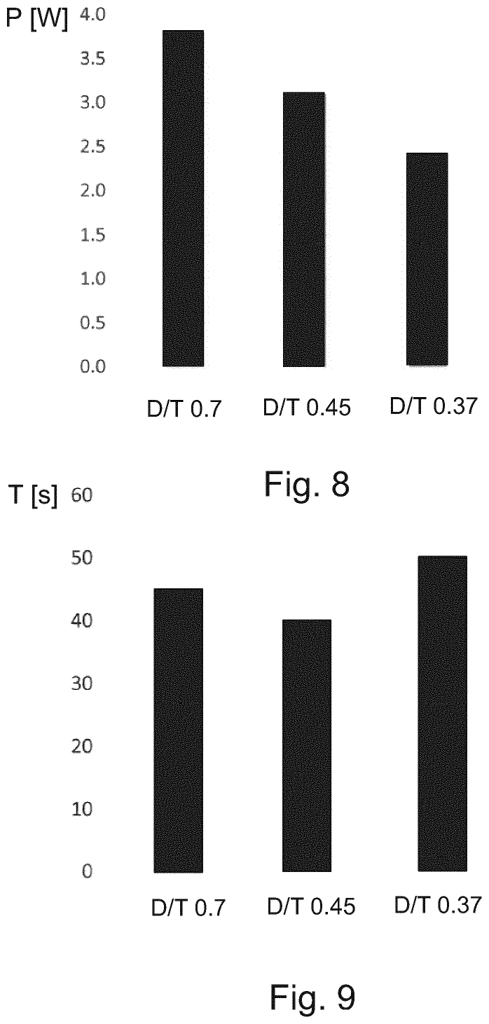

FIG. 8 illustrates power requirements in watts (W) of some arrangements in an experiment, and FIG. 9 illustrates separation time results in seconds (s) in the experiment. The diameter D of the mixing device was varied in the experiment such that values of D/T were 0.7, 0.45 and 0.37. All other dimensions and variables in the experiment were kept constant.

As it can be seen in FIG. 8, the power required for maintaining dispersion through all volume of the solution increases as the diameter D is raising.

FIG. 9 is showing the time for the phase disengagement, i.e. separating the dispersion again into two pure layers, taking place in a settler unit into which dispersion created by the mixing arrangement was fed. As it can be seen, the shortest and thus the most effective phase disengagement took place when the D/T was 0.45.

The invention is not limited solely to the embodiments described above, but instead many variations are possible within the scope of the inventive concept defined by the claims below. Within the scope of the inventive concept the attributes of different embodiments and applications can be used in conjunction with or replace the attributes of another embodiment or application.

The drawings and the related description are only intended to illustrate the idea of the invention. The invention may vary in detail within the scope of the inventive idea defined in the following claims.

### REFERENCE SYMBOLS

1 mixing device
2a, b helical bar
3 shaft
4 support spoke
5 blocking element
6 mixing space
7 side wall
8 motor
9 support element
100 mixing arrangement
200 mixer settler unit
201 settler unit
D diameter of mixing device
H height of helical bars
L liquid surface height
R rotation direction
T diameter of mixing space
TL lower part diameter
TU upper part diameter

1. A mixing arrangement for mixing two solutions, wherein the mixing arrangement comprises a mixing device arranged in the mixing space for rotating therein,
the mixing device comprising at least two helical bars supported around a shaft and rising upwards from the bottom section of the mixing space,
the helical bars being fixed to the shaft with support spokes, wherein
the ratio of the diameter (D) of the mixing device to the average diameter (T) of the mixing space, that is D/T, is 0.47 at most and wherein the ratio D/T is selected in range of 0.38-0.47.

2. (canceled)

3. The arrangement as claimed in claim 1, wherein the ratio D/T is selected in range of 0.40-0.45.

4. The arrangement as claimed in claim 1, wherein the ratio of the height (H) of the helical bars to liquid surface height (L), that is H/L, is 0.6-0.9, preferably 0.8-0.9.

5. The arrangement as claimed in claim 1, wherein the ratio of the height (H) of the helical bars to the diameter (D), that is H/D, is at least 1, preferably 1.5-2.

6. The arrangement as claimed in claim 1, wherein the mixing device comprises at least three helical bars.

7. The arrangement as claimed in claim 1, wherein the helical bar has a round profile.

8. The arrangement as claimed in claim 7, wherein diameter of the helical bar is selected in range of 0.03×T-0.05×T.

9. The arrangement as claimed in claim 1, wherein the supporting spoke is straight, first end attached to the helical bar, and second end arranged to the shaft, wherein and the angle between the spoke and the shaft is 75°-105°, preferably 85°-95°, more preferably 90°.

10. The arrangement as claimed in claim 1, wherein the number of the supporting spokes is 6 to 12.

11. The arrangement as claimed in claim 1, wherein the supporting spoke has a round profile.

12. The arrangement as claimed in claim 1, wherein the mixing space has an upper part and a lower part, and wherein the ratio of the diameter (TU) of the upper part and the diameter (TL) of the lower part is selected in range of 0.8-1.2, preferably 0.9-1.1.

13. The arrangement as claimed in claim 1, wherein the mixing space has a cylindrical shape.

14. The arrangement as claimed in claim 1, wherein the mixing space has a shape of truncated cone.

15. The arrangement as claimed in claim 1, wherein the average diameter (T) of the mixing space is at least 1000 mm, preferably 1000 5000 mm.

16. The arrangement as claimed in claim 1, wherein the mixing space is provided with one or more blocking elements.

17. The arrangement as claimed in claim 16, wherein the blocking element has a shape that extends in the same direction as the shaft.

18. The arrangement as claimed in claim 17, wherein the blocking element is arranged to a side wall of the mixing space.

19. The arrangement as claimed in claim 16, wherein the blocking elements comprise a baffle.

20. A mixer settler unit, comprising the mixing arrangement as claimed in claim 1, and
a settler unit arranged for receiving material from said mixing arrangement.

21. The mixer settler unit as claimed in claim 20, comprising at least two mixing arrangements arranged in series, and
the settler unit arranged for receiving material from the last of said mixing arrangements.

22. Use of the mixing arrangement as claimed claim 1 for solvent extraction in the hydrometallurgical recovery of metals.

23. Use of the mixing arrangement as claimed claim 1 for solvent extraction in the hydrometallurgical recovery of at least one metal, preferably selected from Cu, Ni, Co, Mg, Mn, Zn, Fe, U and B.
